(19) United States
(12) Patent Application Publication
(10) Pub. No.: US 2013/0156016 A1
(43) Pub. Date: Jun. 20, 2013

(54) WIRELESS NETWORK SYSTEMS

(71) Applicant: Texas Instruments Incorporated, Dallas, TX (US)

(72) Inventors: Sankar Prasad Debnath, Bangalore (IN); Brijesh Mani Tripathi, Bangalore (IN); Girish Madpuwar, Bangalore (IN); Ganesan Thiagarajan, Bangalore (IN)

(73) Assignee: Texas Instruments Incorporated, Dallas, TX (US)

(21) Appl. No.: 13/713,374

(22) Filed: Dec. 13, 2012

(30) Foreign Application Priority Data
Dec. 15, 2011 (IN) 4403/CHE/2011
Jan. 31, 2012 (IN) 364/CHE/2012

(51) Int. Cl. H04W 72/04

(52) U.S. Cl. CPC H04W 72/0406
USPC 370/336

(57) ABSTRACT

Several wireless network systems are disclosed. In an embodiment, a wireless network system includes at least two access points and a distributed set of devices communicatively associated with the at least two access points. Each device from among the distributed set of devices comprises a pair of wireless stations and each wireless station from among the pair of wireless stations is configured to transmit data associated with an alert situation to a distinct access point from among the at least two access points. A communication between one or more access points from among the at least two access points and one or more wireless stations from among the pairs of wireless stations corresponding to the distributed set of devices is synchronized based on a timing synchronization information shared by at least two basic service sets (BSSs) corresponding to the at least two access points.

### CROSS REFERENCE TO RELATED APPLICATIONS

This application claims the benefit of provisional patent application number 4403/CHE/2011, filed on Dec. 15, 2011, in the Indian Patent Office, and provisional patent application number 364/CHE/2012, filed on Jan. 31, 2012, in the Indian Patent Office, which are incorporated herein by reference in their entirety.

### TECHNICAL FIELD

The present disclosure generally relates to the field of wireless networks.

### BACKGROUND

Pursuant to an exemplary scenario, monitoring and/or surveillance devices may be deployed over geographical areas in order to remotely track the occurrence of alert situations. Examples of monitoring devices may include, for example, sensors, such as fire sensors, actuators, and the like. Examples of surveillance devices may include, for example, security cameras, audio/video modules for patient health monitoring, and the like. Upon the occurrence of alert situations, such devices may be configured to transmit alert data to an emergency response server, which may be configured to perform an appropriate action. The communication between the emergency response server and the monitoring and/or surveillance devices may be facilitated by means of a wired infrastructure. However, connecting a plurality of devices to the emergency response server through wires/cables may be cumbersome and may involve a relatively high cost. Moreover, such safety-related applications may utilize redundant paths for communicating the alert data to an account for any fault in a transmission channel.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

Various wireless network systems are disclosed. In an embodiment, a wireless network system includes at least two access points and a distributed set of devices communicatively associated with the at least two access points. Each device from among the distributed set of devices comprises a pair of wireless stations and each wireless station from among the pair of wireless stations is configured to transmit data associated with an alert situation to a distinct access point from among the at least two access points. A communication between one or more access points from among the at least two access points and one or more wireless stations from among the pairs of wireless stations corresponding to the distributed set of devices is synchronized based on a timing synchronization information shared by at least two basic service sets (BSSs) corresponding to the at least two access points.

In an embodiment, the at least two access points and the pairs of wireless stations are configured to comply with at least one of a plurality of Institute of Electrical and Electronics Engineers (IEEE) 802.11 protocols for the communication. In an embodiment, each wireless station from among the pair of wireless stations comprises a radio operable individually based on an associated wireless context, where the radio is enabled for a predetermined duration periodically based on a time-sharing paradigm.

In an embodiment, each wireless station from among the pair of wireless stations is configured to transmit the same data associated with the alert situation to distinct access points from among the at least two access points. In an embodiment, the distinct access points configured to receive the transmitted data associated with the alert situation are associated with different service set identifications (SSIDs). In an embodiment, the distinct access points configured to receive the transmitted data associated with the alert situation are associated with a same SSID. In an embodiment, the distinct access points comprise a primary access point and a secondary access point associated with same basic service set identification (BSSID). In an embodiment, the secondary access point is configured to perform one or more functions associated with the corresponding primary access point in an event of operational failure of the primary access point.

In an embodiment, the wireless network system further comprises a server configured to receive the data associated with the alert situation from the at least two access points. In an embodiment, the data is received over at least one of a wireless backhaul connection and a wired backhaul connection. In an embodiment, the server is configured to periodically transmit the timing synchronization information in form of a timing synchronization function (TSF) to the at least two basic service sets (BSSs) corresponding to the at least two access points for subsequent propagation to the pairs of wireless stations at periodic intervals for synchronizing the transmission of the data associated with the alert situation through a same frequency channel.

In an embodiment, the at least two access points are configured to dynamically increase a bandwidth allocation to at least one wireless station from among the pair of wireless stations corresponding to the distributed set of devices upon an occurrence of the alert situation. In an embodiment, each access point from among the at least two access points is configured to be operable in a Wi-Fi repeater mode for propagation of the data associated with the alert situation. In an embodiment, each device from among the set of devices comprises a circuit from among one of (1) a sensor, (2) an actuator, and (3) a user interface.

Additionally, in an embodiment, a wireless network system is provided. The wireless network system includes at least two access points and a distributed set of devices communicatively associated with the at least two access points. Each device from among the distributed set of devices comprises a wireless station configured to periodically switch wireless contexts based on a time-sharing paradigm for transmission of data associated with an alert situation to distinct access points from among the at least two access points. A communication between one or more access points from among the at least two access points and one or more wireless stations corresponding to the distributed set of devices is synchronized based on a timing synchronization information shared by at least two basic service sets (BSSs) corresponding to the at least two access points.

Moreover, in one embodiment, a wireless network system includes a plurality of access points and a distributed set of devices communicatively associated with the plurality of access points. Each device from among the distributed set of devices comprises at least one wireless station configured to transmit data associated with an alert situation to two distinct access points from among the plurality of access points through separate frequency channels.

### BRIEF DESCRIPTION OF THE FIGURES

FIG. 1 depicts an exemplary deployment of monitoring and/or surveillance devices over a geographical area in accordance with an exemplary scenario;

FIG. 2 depicts a block diagram illustrating a first exemplary wireless network system in accordance with an embodiment;

FIG. 3 depicts a block diagram illustrating a second exemplary wireless network system in accordance with an embodiment;

FIG. 4 depicts an exemplary wireless network system and an exemplary transmission of alert data to distinct access points associated with different SSIDs in accordance with an embodiment;

FIG. 5 depicts an exemplary wireless network system with wired backhaul and an exemplary transmission of alert data to distinct access points associated with the same BSSID in accordance with an embodiment;

FIG. 6 depicts an exemplary wireless network system with wireless backhaul and an exemplary transmission of alert data to distinct access points associated with the same BSSID in accordance with an embodiment;

FIG. 7 depicts a timing diagram illustrating an exemplary scheduling of data transmission by wireless stations corresponding to devices associated with a basic service set (BSS) based on a timing synchronization information in accordance with an embodiment;

FIG. 8 depicts a timing diagram illustrating an exemplary scheduling of data transmission by wireless stations corresponding to devices associated with a plurality of BSSs based on a timing synchronization information in accordance with an embodiment;

FIGS. 9A-9B depict a diagrammatic representation for illustrating an exemplary contention free operation of a wireless network system by utilizing frequency multiplexing in accordance with an embodiment; and

FIG. 9C depicts a block diagram that illustrates an exemplary transmission of alert data to a server in the wireless network system of FIGS. 9A and 9B in accordance with an embodiment.

The drawings referred to in this description are not to be understood as being drawn to scale except if specifically noted, and such drawings are only exemplary in nature.

### DETAILED DESCRIPTION

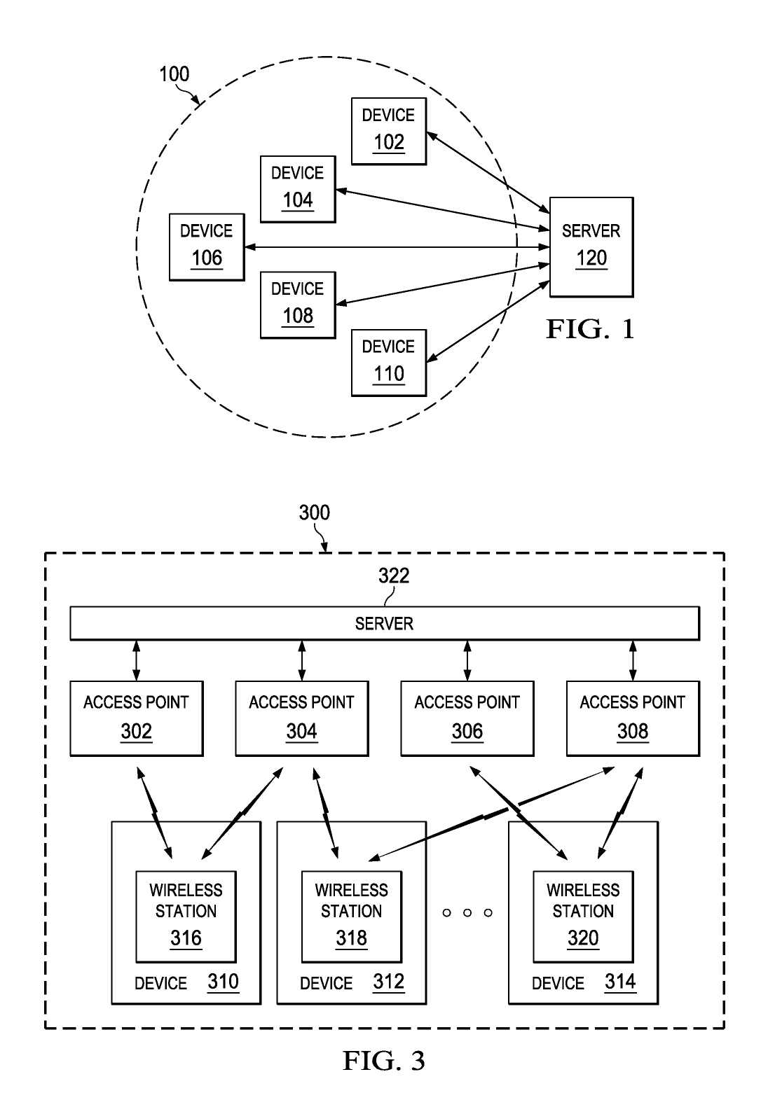

Pursuant to an exemplary scenario, monitoring and/or surveillance devices may be deployed over geographical areas in order to remotely track the occurrence of alert situations. Upon the occurrence of alert situations, such devices may be configured to transmit alert data to an emergency response server, which may be configured to perform an appropriate action. An exemplary deployment of such devices is explained herein with reference to FIG. 1.

FIG. 1 depicts an exemplary deployment of monitoring and/or surveillance devices over a geographical area 100 in accordance with an exemplary scenario. The geographical area 100 may correspond to any indoor or outdoor environment under surveillance/monitoring purview. A plurality of exemplary monitoring and/or surveillance devices, such as monitoring and/or surveillance devices 102, 104, 106, 108 and 110 are shown as being deployed in the geographical area 100. The monitoring and/or surveillance devices are hereinafter collectively referred to as “devices” (for the sake of brevity); it is noted, however, that the term “device” may be construed, for example, as referring to a device other than a monitoring or surveillance device. Examples of the devices may include sensors, such as fire sensors, temperature sensors, pressure sensors, chemical sensors and/or gas sensors, actuators, audio/video user interfaces for remote monitoring, and the like. The devices may be deployed, for example, as a part of a fire security control system, a health monitoring system for hospitalized patients, a theft security system, and the like, for monitoring/surveillance purposes. Each of the plurality of devices may be configured to be responsive to alert situations (for example, emergency situations). An example of an alert situation may be an outbreak of fire. Another example of an alert situation may be a deterioration of a health condition of a patient. Upon, or subsequent to, the occurrence of an alert situation, the devices may be configured to generate data associated with the alert situation and transmit the same to an emergency response server, such as server 120.

In various exemplary scenarios, the devices may be communicatively associated with the server 120 using a wired infrastructure. However, the wired infrastructure may be difficult to scale as a result of numerous wired interconnections. Also, in several exemplary scenarios, proprietary wireless networks may be utilized to facilitate communication between the devices and the server 120. However, deployment of proprietary wireless networks may cause interoperability issues as such networks may be tied to a single operator. Moreover, in addition to being a relatively costly proposition, deployment of the proprietary wireless networks may involve testing for large-scale deployments, as their viability may be unproven for larger scale deployments. Further, the proprietary wireless networks (for example, sub-giga hertz networks) may be associated with reduced battery life as a result of relatively larger transmission power specifications and slow bit rates.

The foregoing notwithstanding, in one exemplary scenario, a Wi-Fi mesh network may be used to facilitate communication between the devices and the server 120. However, the Wi-Fi mesh networks may suffer from interoperability issues and a relatively higher cost as a result of early stages of the adoption of such technology. Moreover, and pursuant to an exemplary scenario, non Wi-Fi networks, such as, for example, sub-giga hertz (GHz)/2.4 GHz radio or Zigbee® networks, may be used to facilitate communication between the devices and the server 120. However, issues with the non-Wi-Fi networks may include non-standard vendor-specific protocols and vendor-specific central control panel(s)/aggregators/bridges, which may cause incremental future upgrades to be difficult. Further, the non Wi-Fi networks (1) may have low peak throughput (for example, a hundred kilo bits per second (Kbps)), (2) may be associated with a relatively higher degree of latency, (3) might not be interoperable/compatible with most classes or richly-functional classes of Wi-Fi enabled devices, and (4) may be unable to carry video traffic during emergencies or for regular surveillance. Various embodiments of the present technology, however, provide wireless network systems that utilize a protocol-compliant wireless local area network (WLAN) to connect an arbitrary number of monitoring/surveillance devices to an IP network with routing redundancy that are capable of overcoming these and other obstacles and providing additional benefits.

The following description and accompanying figures demonstrate that the present technology may be practiced, or otherwise implemented, in a variety of different embodiments. It should be noted, however, that the scope of the present technology is not limited to any or all of the embodiments disclosed herein. Indeed, one or more of the devices, features, operations, processes, characteristics, or other qualities of a disclosed embodiment may be removed, replaced, supplemented, or changed.

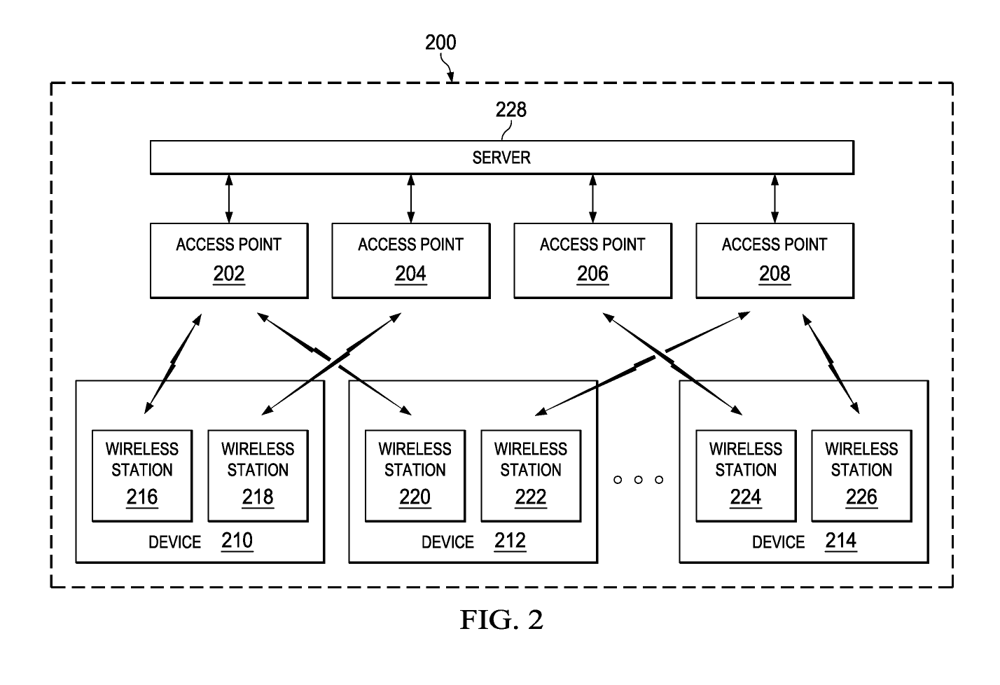

FIG. 2 depicts a block diagram illustrating a first exemplary wireless network system 200 in accordance with an embodiment. The wireless network system 200 is depicted to include access points, such as access points 202, 204, 206 and 208 and a distributed set of devices, such as devices 210, 212 to 214. It is noted that although the wireless network system 200 depicts four access points, the wireless network system 200 may include any number of access points greater than or equal to two access points. Further, it is noted that the distributed set of devices may include ‘n’ number of devices, where n is a positive integer. The term ‘distributed’ as used herein may refer to, for example, a widespread deployment of the devices over a geographical area, such as geographical area 100 of FIG. 1. The access points 202, 204, 206 and 208 are hereinafter collectively referred to as “access points” (for the sake of brevity). The distributed set of devices 210, 212 to 214 are hereinafter collectively referred to as “devices” (for the sake of brevity).

In an embodiment, the devices are configured to be responsive to an alert situation. In an embodiment, each device from among the devices comprises a circuit from among one of: (1) a sensor, (2) an actuator, and (3) a user interface. The circuit included in each device is configured to enable the device to be responsive to the alert situation. For example, the device may include a fire sensor configured to sense an alert situation, such as, for example, an outbreak of fire, and transmit data associated with the alert situation. Similarly, the device may include a user interface configured with audio/video modules, which may enable a remote monitoring of a deteriorating health condition of a patient.

In an embodiment, each device from among the devices comprises a pair of wireless stations. For example, device 210 includes wireless stations 216 and 218. Similarly, device 212 includes wireless stations 220 and 222, and device 214 includes wireless stations 224 and 226. In an embodiment, each wireless station from among the pairs of wireless stations is configured to transmit data associated with the alert situation (hereinafter referred to as ‘alert data’) to a distinct access point. For example, wireless station 216 may transmit the alert data to the access point 202 while the wireless station 218 may transmit the alert data to access point 204 (or another access point distinct from access point 202). In an embodiment, each wireless station from among the pair of wireless stations is configured to transmit the same alert data to distinct access points. For example, the wireless station 220 may transmit the alert data to access point 202 while the wireless station 222 may transmit the same alert data to the access point 208. Transmission of the alert data to two distinct access points provides a redundancy to account for failure of an access point during communication of the alert data for safety-related applications (such as fire emergency and the like). In an embodiment, an access point and the wireless stations associated with the access point for transmission of the alert data may define a basic service set (BSS). For example, access point 208 may receive the alert data from the wireless stations 222 and 226. Accordingly, the access point 208 and the wireless stations 222 and 226 may define a BSS. In an embodiment, at least two BSSs may be defined in the wireless network system 200. In an embodiment, a communication between one or more access points and one or more wireless stations from among the pairs of wireless stations corresponding to the distributed set of devices may be synchronized based on a timing synchronization information shared by the basic service sets (BSSs) corresponding to the access points. The sharing of the timing synchronization information among the BSSs is explained further with reference to FIG. 8. In an embodiment, each wireless station from among the pair of wireless stations may be operable individually in its respective BSS.

In an embodiment, each of the pair of wireless stations may transmit the alert data to the distinct access points at different instances of time based on a time-sharing paradigm. In an embodiment, a handshaking or coexistence protocol may be executed between the pair of wireless stations so as to render the pair of wireless stations to be compliant with the wireless communication protocol that the wireless network system 200 is configured to comply with. In an embodiment, each wireless station from among the pair of wireless stations includes a radio operable individually based on an associated wireless context. The radio may be periodically enabled for a predetermined duration based on a time-sharing paradigm (for example, a pre-determined or a dynamic allotment of time instances at which a radio corresponding to a wireless station may be enabled) that is implemented with respect to the transmission of the alert data. In an embodiment, each of the pair of wireless stations may include separate antennas. In an embodiment, the pair of wireless stations may be configured to utilize a coexistence protocol to control the time of transmission of the alert data and also to share an antenna. The coexistence protocol may include, for example a protocol for Bluetooth® WLAN coexistence and antenna sharing. In an embodiment, the pair of wireless stations may use real-time hardware signaling, as well as software operations, to achieve coordination and time-sharing. The coordination may also be aided further by, for example, synchronizing a time of transmitting the alert data from the pair of wireless stations, selecting a transmit packet size based on the specifications/bandwidth associated with an application layer, or toggling transmit priorities assigned to the pair of wireless stations.

In an embodiment, the access points and the pairs of wireless stations corresponding to the devices are configured to comply with at least one of a plurality of Institute of Electrical and Electronics Engineers (IEEE) 802.11 protocols for the communication. Examples of IEEE 802.11 protocols may include, but are not limited to, IEEE 802.11a, IEEE 802.11b, IEEE 802.11g, IEEE 802.11n and IEEE 802.11ac wireless LAN protocols and the like. More specifically, the access points and the pairs of wireless stations corresponding to the devices may define one or more WLANs. The usage of WLAN for transmission of the alert data provides several advantages. For example, off-the-shelf access points may be utilized for configuring the WLAN in an economical manner. Moreover, the WLAN may be utilized for larger scale deployments without interoperability issues. The fault-tolerance built into the WLAN as a result of transmission of the alert data to two distinct access points further obviates complex interconnections of wired infrastructure. The strict time-to-reach-server parameters may also be met.

In an embodiment, the access points and the devices are configured to utilize relatively narrow, bandwidth-efficient, frequency channels, such as, for example, of 10 mega hertz (MHz), 5 MHz, 2.5 MHz, and the like. During alert situations, the distributed set of devices 210 may transmit distress packets. The distributed set of devices may utilize a specified QoS for improved packet delivery, such as for high bandwidth and/or minimum data errors.

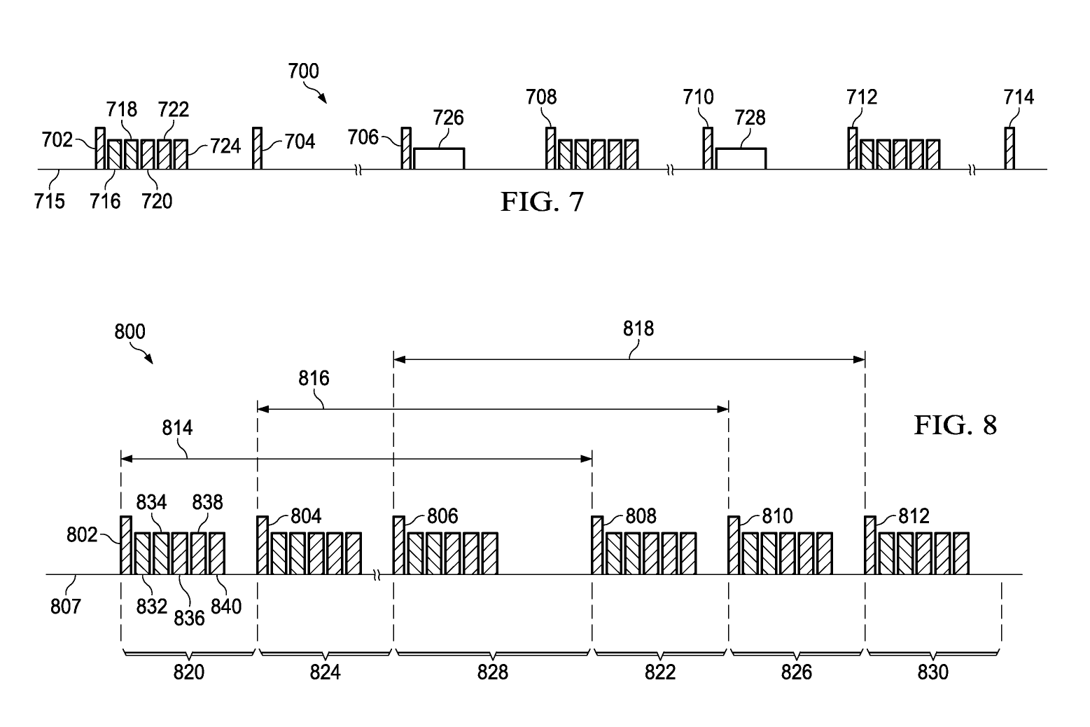

In an embodiment, the wireless network system 200 includes a server 228 configured to receive the alert data from at least two access points (for example, the distinct access points). In an embodiment, the alert data may be received over at least one of a wireless backhaul connection and a wired backhaul connection. In an embodiment, the wired connection may include, for example, an Ethernet backhaul network connection. In an embodiment, each access point may be configured to be operable in a Wi-Fi repeater mode for propagation of the alert data. In an embodiment, an access point is pre-configured to switch to operating as a Wi-Fi repeater upon, or subsequent to, a disruption of power or upon, or subsequent to, a failure of the Ethernet backhaul network connection, thereby ensuring that a disruption of sever access to the devices is either completely avoided or else is rendered gradual in the event of destruction (for example, due to a fire outbreak). In an embodiment, the server 228 is configured to periodically transmit the timing synchronization information in form of a timing synchronization function (TSF) to the at least two basic service sets (BSSs) corresponding to access points for subsequent propagation to the pair of wireless stations at periodic intervals for synchronizing the transmission of the data associated with the alert situation through a same frequency channel (for example, same WLAN channel). The TSF and synchronization of the transmission is further explained herein with reference to FIGS. 7 and 8.

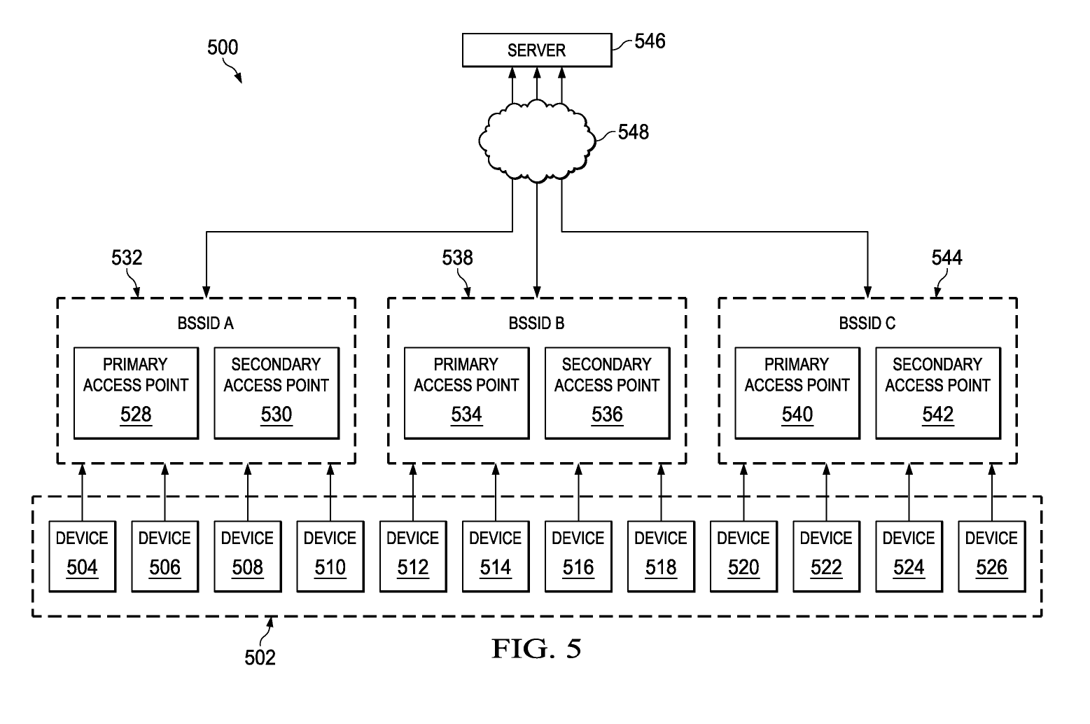

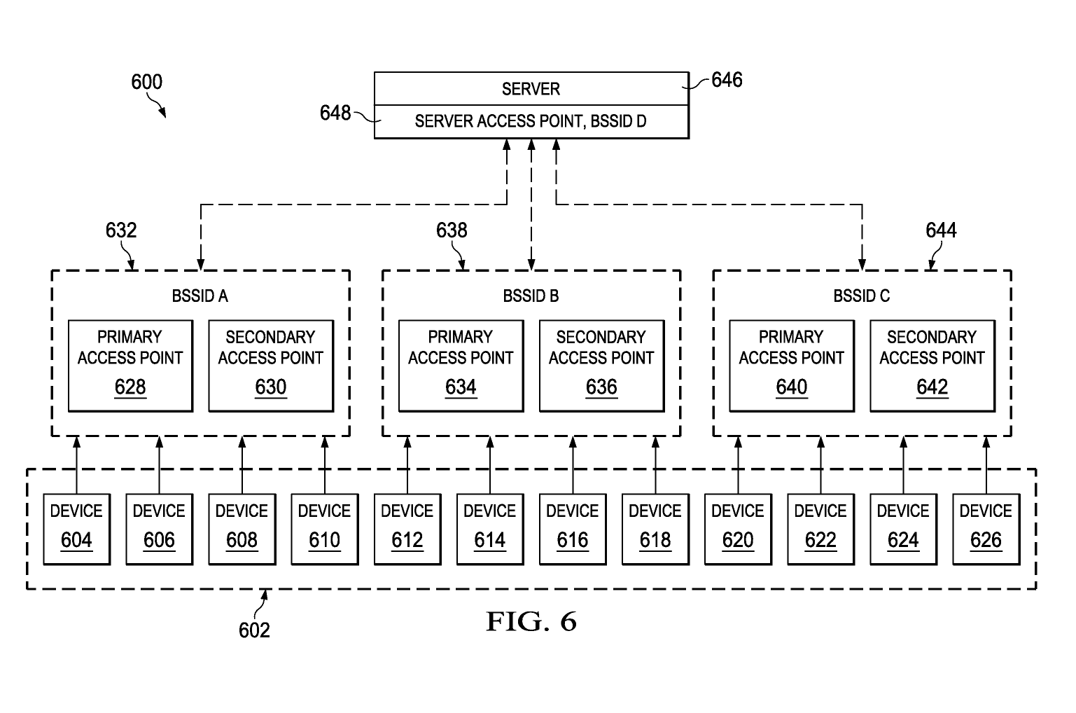

In an embodiment, the distinct access points configured to receive transmitted data associated with the alert situation are associated with different service set identifications (SSIDs). In an embodiment, the distinct access points configured to receive transmitted data associated with the alert situation are associated with the same SSID. The distinct access points associated with one of the same SSID and different SSIDs define redundant paths for transmission of the alert data and are further explained herein with reference to FIGS. 5 and 6. In an embodiment, the distinct access points comprise a primary access point and a secondary access point associated with same basic service set identification (BSSID). In an embodiment, the secondary access point is configured to perform one or more functions associated with the corresponding primary access point in an event of operational failure of the primary access point. The primary access point and the secondary access point are further explained herein with reference to FIG. 5.

In an embodiment, a high peak capacity is provisioned for the wireless network system 200 so as to cover high-speed, full-duplex traffic due to application parameters. The high peak capacity may provide additional capabilities to the distributed set of devices, such as emergency audio announcements during an alert situation. In an embodiment, the access points are configured to dynamically increase bandwidth allocation to at least one wireless station from among the pairs of wireless stations corresponding to the set of devices upon, or subsequent to, the occurrence of the alert situation. In some embodiments, the higher peak traffic or bandwidth capacity supports value-added functionality, such as, for example, built-in audio/video scanning capability in devices equipped with a fire sensor circuit.

In an embodiment, the WLAN may be operable in conjunction with a previously existing WLAN infrastructure co-located at the same geographical area. In an embodiment, the transmission of the alert data may be conducted utilizing a separate frequency channel than that being utilized by the existing WLAN infrastructure. In an embodiment, each of the devices may be powered by batteries. In an embodiment, each access point from among the access points may be configured to be powered by batteries, in addition to a line power supply or a power-over-Ethernet supply. In an embodiment, powering of access points by batteries may ensure uninterrupted operation in the event of a power outage, such as during a fire outbreak. An exemplary wireless network system with each of the distributed set of devices including a single wireless station is described herein with reference to FIG. 3.

FIG. 3 depicts a block diagram illustrating a second exemplary wireless network system 300 in accordance with an embodiment. The wireless network system 300 is depicted to include access points, such as access points 302, 304, 306, and 308 and a distributed set of devices, such as devices 310, 312 to 314. It is noted that although the wireless network system 300 depicts four access points, the wireless network system 300 may include any number of access points greater than or equal to two access points. The access points 302, 304, 306 and 308 are substantially similar to the access points 202-208 explained herein with reference to FIG. 2. Further, it is noted that the distributed set of devices may include ‘n’ number of devices, where n is a positive integer. The access points 302-308 are hereinafter collectively referred to as “access points” (for the sake of brevity). The distributed set of devices 310-314 are hereinafter collectively referred to as “devices” (for the sake of brevity). In an embodiment, each device from among the devices comprises a wireless station. For example, device 310 includes wireless station 316. Similarly, device 312 includes wireless station 318, and, device 314 includes wireless station 320.

In an embodiment, each wireless station is configured to switch wireless contexts periodically based on a time-sharing paradigm (for example, the time-sharing paradigm explained herein with reference to FIG. 2) that is implemented with respect to the transmission of the alert data to distinct access points. For example, wireless station 316 may transmit the alert data to the access point 302, and, subsequently, the wireless station 316 may switch a wireless context based on the time-sharing paradigm and transmit the alert data to access point 304. In an embodiment, each wireless station is configured to transmit the same alert data to distinct access points. For example, the wireless station 318 may transmit the alert data to access point 304 and may subsequently transmit the same alert data to access point 308. Transmission of the alert data to two distinct access points provides requisite redundancy to account for failure of an access point during communication of the alert data for safety-related applications (such as fire emergency and the like).

In an embodiment, switching a wireless context (e.g., time multiplexing between or among different BSS contexts) may create two virtual wireless stations. It is noted that the term “wireless context” may be construed as referring to, for example, a plurality of network parameters, hardware settings and software data-structures unique to a basic service set (BSS). Examples of the wireless context include, but are not limited to, a Wi-Fi driver software context, a receiver/transmitter packet buffer, one or more channel/radio parameters, one or more power save settings, an encryption parameter, an authentication parameter, one or more session parameters, a different set of data-structures in the case of a process based media access control (MAC) and associated MAC physical radio frequency hardware engine re-initialization. The switching of wireless contexts may be either software managed or hardware assisted (for example, using shadow memories and a scan chain based register context save/restore).

Apart from the single wireless station configuration, in an embodiment, the devices (device 310 to 314) are similar in all respects to the devices 210 to 214 explained herein with reference to FIG. 2. For example, in one embodiment, the set of devices 310 to 314 comprises a circuit from among one of (1) a sensor, (2) an actuator, and (3) a user interface, and is configured to be responsive to alert situations, such as the alert situation explained herein with reference to FIG. 2. Further as explained herein with reference to FIG. 2, the access points and the wireless stations corresponding to the distributed set of devices are configured to comply with at least one of a plurality of IEEE 802.11 protocols for the communication of the alert data, thereby configuring a WLAN configuration with its stated advantages. Examples of IEEE 802.11 protocols may include but are not limited to IEEE 802.11a, IEEE 802.11b, IEEE 802.11g, IEEE 802.11n and IEEE 802.11 ac wireless LAN protocols and the like.

The wireless network system 300 is further depicted to include a server 322, which is similar to the server 228 of FIG. 2. The server 322 is configured to receive the alert data from at least two access points from among the access points 302-308. In an embodiment, the alert data may be received over at least one of a wireless backhaul connection and a wired backhaul connection. In an embodiment, the wired connection may include, for example, an Ethernet backhaul network connection. In an embodiment, the server 322 is configured to periodically transmit the timing synchronization information in form of a timing synchronization function (TSF) to the BSSs corresponding to the access points for subsequent propagation to the pair of wireless stations at periodic intervals for synchronizing the transmission of the data associated with the alert situation through a same frequency channel.

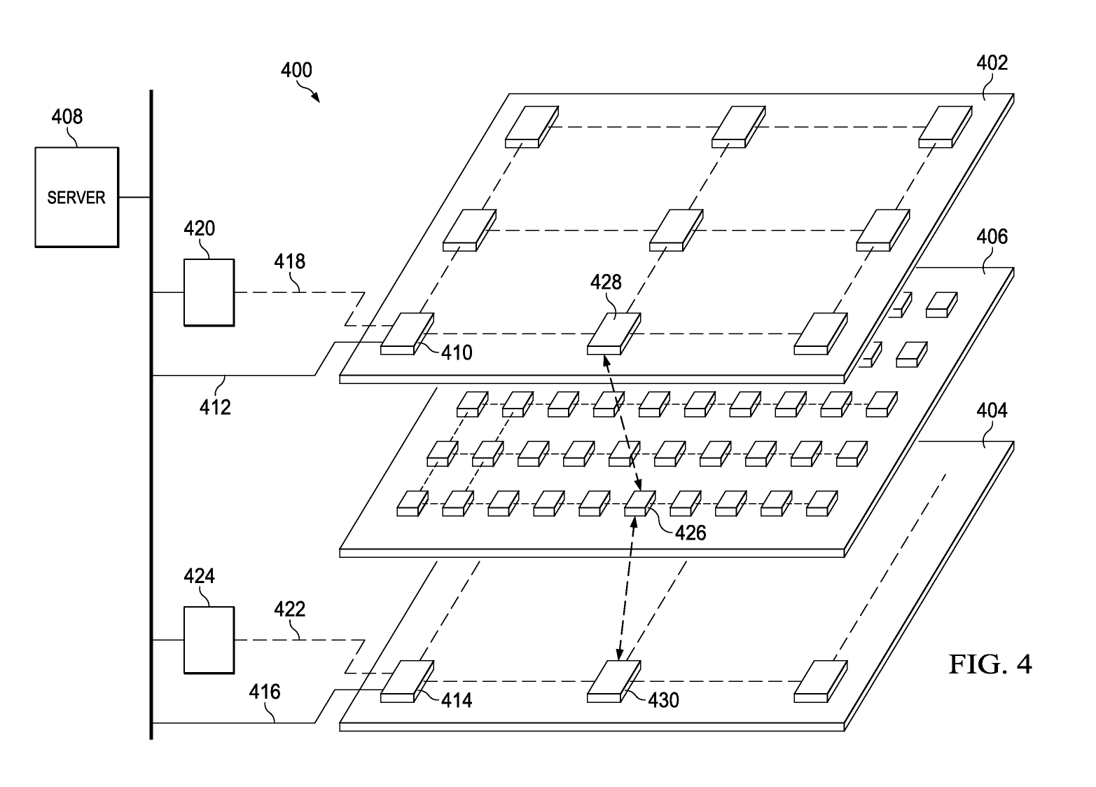

In an embodiment, the distinct access points configured to receive transmitted data associated with the alert situation are each associated with one of a different SSIDs and a same SSID. An exemplary scenario depicting the transmission of the alert data to the distinct access points associated with different SSIDs is further explained herein with reference to FIGS. 4 and 5.

FIG. 4 depicts an exemplary wireless network system 400 and an exemplary transmission of alert data to distinct access points associated with different SSIDs in accordance with an embodiment. The wireless network system 400 is depicted to include a first set of access points (depicted to be distributed in an upper diagrammatic plane 402) and a second set of access points (depicted to be distributed in a lower diagrammatic plane 404). In an embodiment, the first set of access points may logically define a first WLAN. The first WLAN may be associated with a first SSID. In an embodiment, the second set of access points may logically define a second WLAN. The second WLAN may be associated with a second SSID. The foregoing notwithstanding, in one exemplary scenario, the first WLAN and the second WLAN may be associated with same SSID. The first WLAN and the second WLAN may have overlapping physical coverage as the upper diagrammatic plane 402, and the bottom diagrammatic plane 404 are depicted as encompassing the same geographical area.

The wireless network system 400 further includes a set of devices (such as devices 210 to 214 of FIG. 2 and/or devices 310 to 314 of FIG. 3) depicted to be distributed in an intermediate diagrammatic plane 406 (for example, in the same geographical area as the first set of access points and the second set of access points). In an embodiment, each of the distributed set of devices is communicatively associated with an access point (for example, a first access point) from among the first set of access points and an access point (for example, a second access point) from among the second set of access points. For example, if a device from among the set of devices includes a single wireless station as explained herein with reference to FIG. 3, then the wireless station may be communicatively associated with the first access point and then, upon, or subsequent to, a changing of a wireless context, be associated with the second access point. The foregoing notwithstanding, in one embodiment, if the device from among the set of devices includes a pair of wireless stations as explained herein with reference to FIG. 2, then a wireless station of the device may be associated with the first access point and the other wireless station of the device may be associated with the second access point. In an embodiment, each device is associated with a nearest access point in the first SSID and a nearest access point in the second SSID.

In an embodiment, each of the plurality of access points associated with each of the first SSID and/or the second SSID may be associated with a unique basic service set identification (BSSID). In an embodiment, the plurality of access points associated with each of the first SSID and/or the second SSID are communicatively associated with a server 408 through a wired backhaul network, such as, for example, an Ethernet. In an embodiment, an access point from among each of the first set of access points and the second set of access points may be communicatively associated with the server 408 through the wired backhaul network, and the remaining access points in each of the first set and the second set of access points may be configured to be operable as Wi-Fi repeaters. For example, an access point 410 from among the first set of access points may be communicatively associated with a first wired backhaul network 412, and an access point 414 from among the second set of access points may be communicatively associated with a second wired backhaul network 416. The remaining access points from among each of the first set of access points and the second set of access points may be configured as Wi-Fi repeaters in order to extend a range of the first and the second WLANs, respectively. In one embodiment, a plurality of access points associated with each of the first SSID and/or the second SSID are communicatively associated with the server 408 through the wired backhaul networks 412 and/or 416. In an embodiment, an access point from among each of the first set of access points and the second set of access points is connected to the server 408 through wireless backhaul networks. For example, the access point 410 is connected to the server 408 through a first wireless backhaul network 418 via a first wireless access point 420 associated with the server 408, and the access point 414 is connected to the server 408 through a second wireless backhaul network 422 via a second wireless access point 424 associated with the server 408. In an embodiment, the access points associated with the first WLAN and the second WLAN may remain connected to the server 408 through both the wired and wireless backhaul networks in order to provide robustness in safety-related applications.

As explained herein, each device from among the devices remains communicatively associated (for example, in a wireless manner) with an access point associated with the first SSID and an access point associated with the second SSID. In an embodiment, a data packet from each of the set of devices is transmitted to the distinct access points in the first and the second SSIDs. For example, alert data from a device 426 may be transmitted (for example, by utilizing one or more wireless stations associated with the device 426) to an access point 428 associated with the first SSID and an access point 430 associated with the second SSID, thereby forming a pair of redundant communication paths to the server 408. The alert data may be transmitted in the form of a pair of separate data packets in the redundant communication paths, to same destination corresponding to the server 408. In an embodiment, upon reaching the server 408, the duplicate data packets may be discarded. The redundant communication paths provide robustness for safety-related applications.

FIG. 5 depicts an exemplary wireless network system 500 with wired backhaul and an exemplary transmission of alert data to distinct access points associated with the same BSSID in accordance with an embodiment. As explained herein with reference to FIGS. 2 and 3, the alert data may be transmitted by one or more wireless stations to distinct access points associated with the same SSID. Further, the alert data may be transmitted to the distinct access points associated with the same BSSID (within the SSID) as depicted in conjunction with wireless network system 500.

The wireless network system 500 includes a distributed set of devices 502, including a plurality of devices 504 to 526, as depicted in FIG. 5. The distributed set of devices 502, in accordance with one embodiment, is substantially similar to the devices of FIG. 2 or FIG. 3. In an embodiment, each device from among the distributed set of devices 502 is powered by one or more batteries. In an embodiment, each device from among the distributed set of devices 502 is communicatively associated with two distinct access points associated with the same BSSID and the same SSID. For example, each of the devices 504 to 510 is communicatively associated with two distinct access points 528 and 530 associated with BSSID A 532, each of the devices 512 to 518 is communicatively associated with two distinct access points 534 and 536 associated with BSSID B 538, and each of the devices 520 to 526 is communicatively associated with two distinct access points 540 and 542 associated with BSSID C 544. Each of the access points 528, 530, 534, 536, 540, and 542 are communicatively associated with a server 546 through a wired backhaul 548, such as, for example, an Ethernet backhaul network. In each BSSID, from among the two distinct access points, an access point may be assigned as a primary access point and another access point may be assigned as a secondary access point. For example, the access points 528, 534, and 540 may be assigned as the primary access points, and the access points 530, 536, and 542 may be assigned as the secondary access points corresponding to BSSID 532, 538, and 544, respectively. In an embodiment, the primary access points and the secondary access points are collocated (for example, are located at geographically overlapping but substantially separate regions) and collectively define redundant communication paths between each of the distributed set of devices 502 and the server 546. In an embodiment, the primary and the secondary access points are line powered and are effectively always on. The secondary access points are configured to perform one or more functions associated with the corresponding primary access point in an event of operational failure of the primary access point.

In an embodiment, the primary access point is assigned the responsibility of transmitting a beacon to the set of devices and responding to the set of devices. The secondary access points are also configured to receive the data associated with the alert situation from the pair of wireless stations upon occurrence of an alert situation. The secondary access points are configured to remain in a “listen” mode and transmit frames to the distributed set of devices 502 in the event of the eventuality, such as operational failure or malfunction of the primary access point, During the “listen mode” the secondary access points are configured to only receive communication from, for example the server 546 and are not enabled to transmit data. In the event of the eventuality, the secondary access points are configured to take up the functionalities of the corresponding primary access point of the same BSSID and transmit data associated with the alert situation to the server 546. The secondary access points are also herein referred to as shadow access points as they mirror the functionalities of the corresponding primary access point in an event of failure of operation of the primary access point. The alert data from each device from among the distributed set of devices 502 is transmitted to both the corresponding primary and the shadow access points, as both the corresponding primary access point and the shadow access points have the same BSSID. In an embodiment, the transmission of the data to the primary and the shadow access points by each of the distributed set of device 502 is synchronized based on a time synchronization function (as is further explained herein with reference to FIGS. 7 and 8).

In an embodiment, the primary access points and the shadow access points transmit a message termed as “heart beat” to the server 546, thereby indicating their ability to function correctly and thereby signifying an absence of a malfunction of the access points. In an embodiment, the “heart beat” message may be transmitted at least on a per target beacon transmission time basis. In an embodiment, a non-receipt of the “heart beat” message from an access point is indicative of a malfunction of the corresponding access point. In an embodiment, in the event of the malfunction of the primary access point, the server 546 signals the shadow access point of the corresponding BSSID in order to take over the role of the primary access point, and the primary access point may be marked or flagged for repair.

In an embodiment, the distributed set of devices 502 are configured to periodically wake up (for example, are actuated to communicate with the access points) to receive a beacon from the corresponding primary access point and to transmit alert data at a scheduled interval as prescribed in the beacon. Non-receipt of data from a device for a considerable duration of time may be interpreted as a failure of the device, and the primary or the shadow access point may be accordingly configured to indicate the failure to the server 546. In an embodiment, each device from among the distributed set of devices 502 may also be configured to transmit data associated with battery health to the primary and shadow access points in order to help ease the maintenance work of the distributed set of devices 502.

In an embodiment, each device from among the distributed set of devices 502 may be configured to be authenticated with the primary access point during installation of the wireless network system 500 or may be authenticated during the addition of the corresponding device to the wireless network system 500. In an embodiment, the authentication may be initially performed based on a pre-shared key and then subsequently performed based on a security key that may be configured and used after the aforementioned initial performance.

FIG. 6 depicts an exemplary wireless network system 600 with wireless backhaul and an exemplary transmission of alert data to distinct access points associated with the same BSSID in accordance with an embodiment. As explained herein with reference to FIG. 5, the alert data may be transmitted by one or more wireless stations to distinct access points associated with the same SSID. Further, the alert data may be transmitted to the distinct access points associated with the same BSSID (within the SSID), such as depicted herein in conjunction with wireless network system 600. The wireless network system 600 includes a distributed set of devices 602, including a plurality of devices 604 to 626, as depicted in FIG. 6. The distributed set of devices 602 is substantially similar to the distributed set of devices 502 of FIG. 5. In an embodiment, each device from among the distributed set of devices 602 is powered by one or more batteries. In an embodiment, each device from among the distributed set of devices 602 is communicatively associated with two distinct access points associated with the same BSSID and the same SSID. For example, each of the devices 604 to 610 is communicatively associated with two distinct access points 628 and 630 associated with BSSID A 632, each of the devices 612 to 618 is communicatively associated with two distinct access points 634 and 636 associated with BSSID B 638, and each of the devices 620 to 626 is communicatively associated with two distinct access points 640 and 642 associated with BSSID C 644. Each of the access points 628, 630, 634, 636, 640, and 642 are communicatively associated with a server 646 through a wireless backhaul and through a server access point 648 associated with BSSID D.

In each of BSSID A, B and C, from among the distinct access points, an access point may be assigned as a primary access point, and another access point may be assigned as a secondary access point (for example, a shadow access point as explained herein with reference to FIG. 5). For example, the access points 628, 634, and 640 may be assigned as primary access points, and the access points 630, 636, and 642 may be assigned as secondary access points corresponding to BSSID 632, 638, and 644, respectively. The primary access points and the secondary access points are collocated and collectively define a redundant communication path between each of the distributed set of devices 602 and the server 646. Each of the primary access points 628, 634, and 640 and each of the secondary access points 630, 636, and 642 are communicatively associated with the server 646 through the wireless backhaul network, such as a Wi-Fi network.

In an embodiment, each of primary access points 628, 634, and 640 and each of the secondary access points 630, 636, and 642 are configured to operate with a dual role, such that they operate as access points while communicating with the distributed set of devices 602 and as wireless stations while communicating with the server 646. In an embodiment, while operating as access points for the distributed set of devices 602, each of the primary access points 628, 634, and 640 and each of the secondary access points 630, 636, and 642 operate substantially similar to the primary access points and the secondary access points described herein with reference to FIG. 5. In an embodiment, while operating as wireless stations for communicating data to the server 646, the primary access points 628, 634, and 640 and each of the secondary access points 630, 636, and 642 are configured to also operate as access points simultaneously such that the operation as access points and as wireless stations is performed in a different BSS.

In an embodiment, the server 646 is configured to utilize different orthogonal frequency channels for communicating with the access points. In an embodiment, the server 646 is configured to time-share the frequency channel with a plurality of BSSs other than the BSS associated with the wireless network system 600. In an embodiment, the server 646 is configured to utilize a contention-based scheme, such as enhanced distributed channel access (EDCA), or a contention free scheme, such as hybrid coordination function controlled channel access (HCCA), for time sharing. Synchronization of communication by the wireless stations corresponding to the set of devices associated with a BSS and among a plurality of BSSs is explained herein with reference to FIGS. 7 and 8.

FIG. 7 depicts a timing diagram 700 illustrating an exemplary scheduling of data transmission by wireless stations corresponding to devices associated with a BSS based on a timing synchronization information in accordance with an embodiment. The transmission of the alert data by the wireless stations may be time synchronized (for example, scheduled) so as to minimize collisions during transmission and to enable a contention free transmission. In an embodiment, the collisions may be minimized in order to extend a battery life of the distributed set of devices, such as the distributed set of devices 502 and/or 602. In an embodiment, a contention free transmission provides guaranteed time of service in the wireless network system, such as wireless network systems 200, 300, 400, 500 and 600 explained herein with reference to FIGS. 2 to 6.

In an embodiment, a management message (including the timing synchronization information) is transmitted from a server (such as the server 546 or the server 646 of FIGS. 5 and 6, respectively) to an access point corresponding to a BSS in the wireless network system. In an event of a BSS including a primary access point and a secondary access point, such as in the case of wireless network systems 500 and 600, the management message may be sent to the primary access point and the secondary access point. In the event of the backhaul network being facilitated by wireless means, the management message may take a form of a beacon frame. For wired backhaul networks, similar management message frame may be transmitted to the one or more access points corresponding to the BSS.

Subsequently, the timing synchronization information is transmitted from the access point to the distributed set of devices in the form of a timing synchronization function (TSF) in the beacon frame. In an embodiment, the same TSF is transmitted to all devices associated with the BSS. In an embodiment, the TSF is shared by a plurality of basic service sets (BSSs) associated with the wireless network system of the present technology. In an embodiment, the TSF enables maintaining same time base across the plurality of BSSs. In an embodiment, transmission of the timing synchronization information from the server may be an asynchronous event with respect to beacon transmission by the access point. The beacon may be transmitted by the access point at periodic instances of time. For example, as depicted by instances on a time-line 715 in FIG. 7, the beacon is transmitted during instances 702, 704, 706, 708, 710, 712 and 714. In the event of the BSS including a primary access point and a secondary access point, such as those described herein with reference to FIGS. 5 and 6, the primary access point is configured to transmit the beacon to the associated devices from among the distributed set of devices. The beacon includes a TSF (for example, timing synchronization information) and additional information, which may be indicative of a plurality of constraints for transmission of the alert data from the device to the access point. Examples of constraints may include, but are not limited to, a predetermined transmit profile, a predetermined amount of data to be transmitted, a predetermined periodicity of transmission of data, and the like.

The predetermined transmit profile includes a specification that is indicative of a predetermined duration or a transmit window allotted for each device to transmit the alert data to at least two access points in order to avoid contention. As depicted in FIG. 7, a beacon is transmitted to n devices from among the distributed set of devices at an instance 702, with n being a positive integer. Each device wakes up to receive the beacon and correct a local time (indicated by the TSF) maintained locally by each device. The TSF maintained by each of the distributed set of devices may differ due to jitter in a clock source used by each of the distributed set of devices and the TSF embedded in the beacon transmitted at periodic instances of time to each of the devices enables synchronizing a timing reference of each of the devices. After reception of the beacon, each of the device prepares to transmit the sensed alert data during a scheduled time slot as prescribed in another management message as per Wi-Fi protocol. For example, as depicted in FIG. 7, a first device from among the n devices transmits data during a time slot 716 after receiving the beacon. Similarly, the second, third, fourth and the nth device may transmit data during time slots 718, 720, 722 and 724 to the at least two access points. In an embodiment, the transmission of data from the devices may be scheduled to occur immediately or relatively soon, after the receipt of the beacon, such as, for example, at instance 704, so as to minimize an awake period of the devices. Such a scheduling may be accomplished by a MAC protocol (existing or otherwise) or by an application level protocol, which may be feasible provided the data traffic is substantially low.

In an embodiment, subsequent to receiving the beacon, the devices may sense alert data from the environment but may not transmit data to the at least two access points. For example, during instances 726 and 728, the n devices sense data from the environment but do not transmit the alert data. However, upon, or subsequent to, receiving a subsequent beacon at instance 708, the n devices may transmit at scheduled time slots, such as explained earlier herein. The n devices may also receive the beacon and may remain awake but may neither collect data from the environment nor transmit the alert data, such as, for example, upon, or subsequent to, receiving a beacon at instance 714. The devices may practice such a behavior in order to conserve power and extend battery life.

In an embodiment, if a need for a higher traffic bandwidth arises, an application level time slotting may be suspended, such as during a fire outbreak. However, the MAC-based protocol does not need to be overridden during such instances. In an embodiment, the device may maintain a continuous connection with at least two access points associated with the same or different SSIDs. As explained herein, in some embodiments, a device may include a single wireless station configured to time multiplex as two stations between different wireless contexts so as to transmit data to the at least two access points. In such embodiments, the wireless station sleeps in, for example, extreme-low power sleep in WLAN between successive receipts of the beacons. In an embodiment, upon, or subsequent to, waking up, the wireless station time multiplexes between different wireless contexts so as to transmit data to the at least two access points. In an embodiment, while waking up for the ‘even’ beacon, a MAC subsystem loads an access point context associated with a first BSSID of a first access point from among the at least two access points, and, while waking up for the ‘odd’ beacon, the MAC subsystem loads the access point context associated with a second BSSID of a second access point from among the at least two access points. In an embodiment, upon, or subsequent to, a transmit packet buffer associated with the first BSSID being empty and another buffer associated with the second BSSID being full, the access point context is switched. A scheduling of data transmission by wireless stations corresponding to the set of devices may not be limited to a single BSS and instead may be extended across a plurality of BSSs. Such a scheduling of data transmission across BSSs is explained herein with reference to FIG. 8.

FIG. 8 depicts a timing diagram 800 illustrating an exemplary scheduling of data transmission by wireless stations corresponding to devices associated with a plurality of BSSs based on a timing synchronization information, in accordance with an embodiment. A scheduling of the data transmission may be employed in wireless network systems, such as wireless network systems 200, 300, 500 and 600 of FIGS. 2, 3, 5, and 6, respectively, in order to enable a time-sharing of a single frequency channel between the BSSs. As explained herein with reference to FIG. 7, a management frame, such as, for example, a beacon, may be transmitted from a server (such as a server 546 or server 646 of FIGS. 5 and 6, respectively) to access points (or, for example, to the primary access point and the shadow access point) corresponding to the plurality of BSSs in the wireless network system. The timing information in the form of a time synchronization function (TSF) is further propagated from the access points to the devices in the respective BSSs. In the event of the BSS including a primary access point and a secondary access point, such as those described with reference to FIGS. 5 and 6, the primary access point is configured to transmit the beacon to the associated devices from among the distributed set of devices. The beacon includes timing synchronization information in form of a TSF, such as the TSF explained herein with reference to FIG. 7. The TSF is used as reference to allocate a time slot to each BSS during which the devices associated with the BSS are allowed to transmit the alert data to the at least two access points. Since a plurality of BSSs may share the frequency channel, the time slot allocated to each of the plurality of BSSs is tightly controlled. The allocated time slot is such that a collective time slot allocated to all the BSSs in the wireless network system is of less duration than a target beacon transmit time, that is N×(T_dur+T_buf)<TBTT, where T_dur is the duration of time allocated to each BSS, T_buf is an idle transition time between two BSS, N is a total number of BSSs in the wireless network system, and TBTT is a target beacon transmit time. The TBTT for each beacon across all the BSSs in the wireless network system is the same, however they are staggered in time.

It is noted that the term “TBTT” may be construed, for example, as referring to a periodicity in time during which an access point associated with each BSS is configured to send a beacon to the distributed set of devices. For example, in the timing diagram 800, a first beacon is transmitted by a first BSS at an instance 802, by second BSS at an instance 804, and by a third BSS at an instance 806 of time 807. A subsequent beacon is transmitted by the first BSS at an instance 808, by the second BSS at an instance 810, and by the third BSS at an instance 812. The TBTT may then be the duration of time represented by each of 814, 816 and 818. It is noted that transmission by a BSS as referred herein implies transmission by an access point associated with the BSS. In an embodiment, a plurality of wireless stations associated with the distributed set of devices corresponding to each BSS are allowed to occupy the frequency channel for a duration of time that is less than or equal to T_dur. Accordingly, T_dur staggers the beacon transmission across the BSSs. As depicted in FIG. 8, the first BSS is allocated T_dur 820 and T_dur 822, the second BSS is allocated T_dur 824 and T_dur 826 for transmitting the beacon and receiving alert data from the distributed set of devices. The third BSS is allocated T_dur 828 and T_dur 830 for transmitting the beacon and receiving the alert data from the distributed set of devices. During the T_dur 820 for the first BSS, a first device associated with the first BSS is allocated a time slot 832 for transmitting alert data. Similarly a second device, a third device, a fourth device and a nth device associated with the first BSS is allocated time slots 834, 836, 838 and 840, respectively, for transmitting the alert data.

In an embodiment, the access points of the inactive BSS (including for example, rest of the BSSs of the wireless network except for the ones that transmit the beacon) are configured to block the frequency channel for duration TBTT-T_dur by transmitting a control frame at high priority. In an embodiment, a medium blocking frame is transmitted by the access point for blocking the distributed set of devices from transmitting on the frequency channel. In an embodiment, a network allocation vector (NAV) may be used to block the frequency channel during a time slot allocated for other BSS. For example, as depicted in FIG. 8, during time slots 824 and 828, the wireless stations associated with the first BSS are blocked for the transmission of data. Similarly, during time slots 828 and 822, the wireless stations associated with the second BSS are blocked for the transmission of data, and, during time slots 822 and 826, the wireless stations associated with the third BSS are blocked for the transmission of data.

In an embodiment, a maximum number of devices in each wireless network system is configured to be less than TBTT/Tₜ, where T₁ is a typical transmit time associated with each device. In an embodiment, in order to maintain the allocated time slot such that N×T_dur<TBTT, each device from among the distributed set of devices associated with the wireless network system share the same time-line across a plurality of BSSs. The time-line is maintained the same based on a TSF transmitted from the server to each device from among the distributed set of devices through the access points. Although the server synchronizes the various access points with the transmitted TSF, there may be a slight change in an actual time slot maintained at the access point as a result of an internal processing delay. However, the slight change in the time slot does not cause a loss of efficiency (in terms of power) for the devices. In an embodiment, a period during which the devices remain awake (e.g., are allowed to transmit data) and the period during which the devices sleep (e.g., are not allowed to transmit data) are maintained based on the TSF propagated by the access points associated with a BSS, and the TSF is local to each BSS.

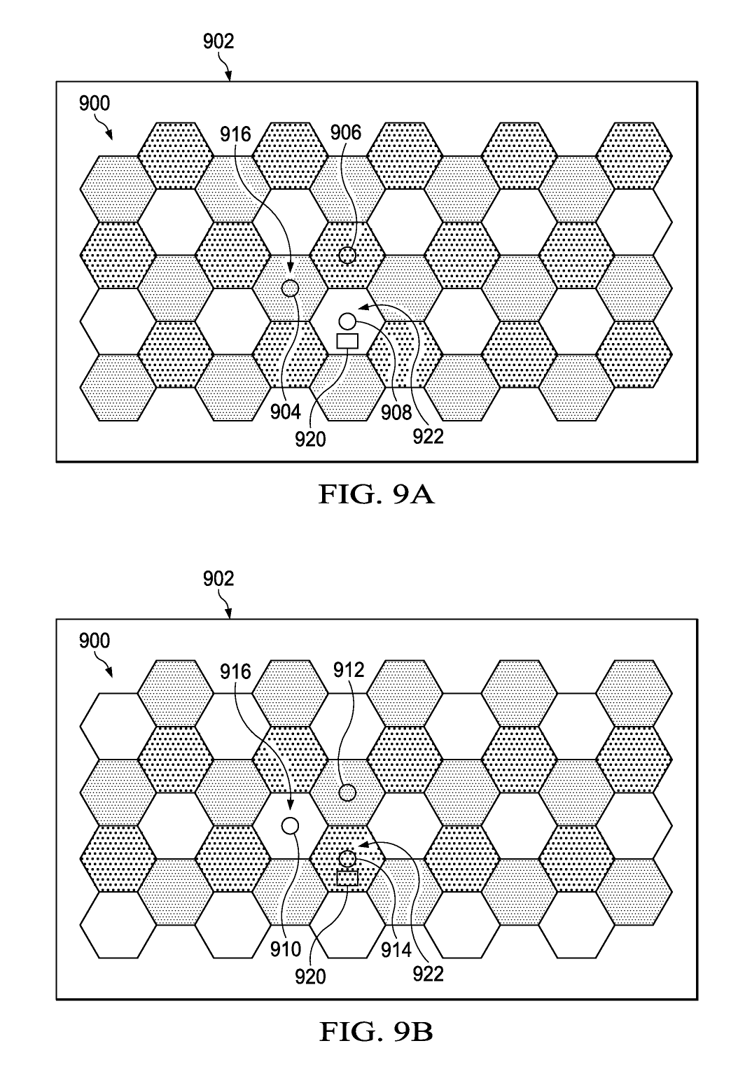

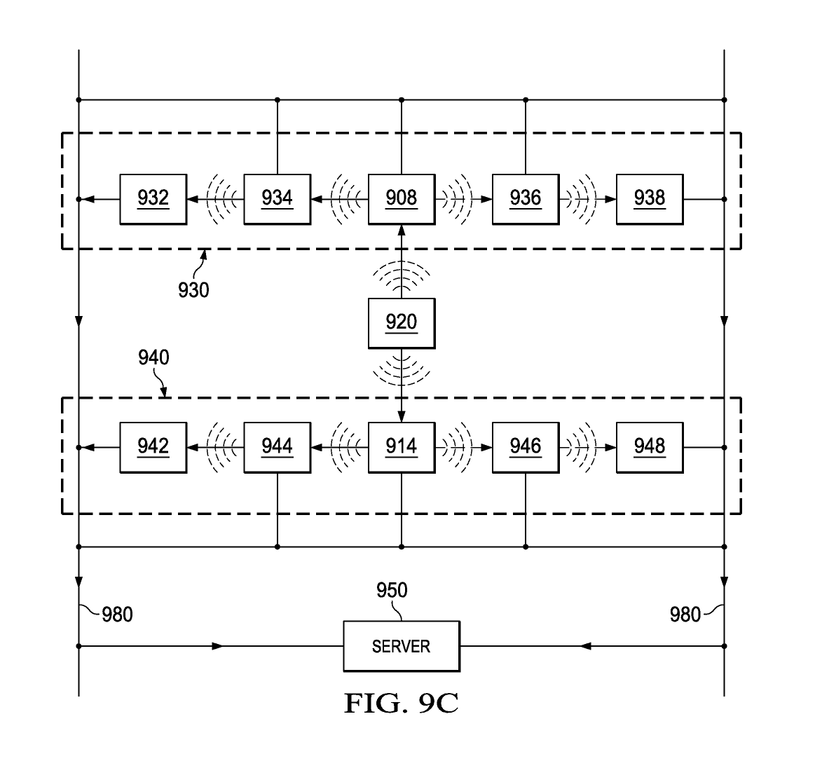

The distributed set of devices in the BSSs may operate at different clocks speeds, and, consequently, a buffer period (same as T_buf) may be maintained for each BSS while other BSSs prepare for the transmission of the alert data. The buffer period avoids accidental collision of transmission from the wireless stations associated with one BSS with the beacon associated with the other BSSs during a transition period from one BSS to the other. In an embodiment, a primary access point transmits the beacon to the distributed set of devices associated with the primary access point at the beginning of the process. In an embodiment, the primary access point and/or the secondary access point (for example, the shadow access point) adopts the TSF and maintains a track of time until a subsequent TSF is received from the server. Also, the primary or the shadow access points adjust the TSF for a local receive delay and loads the TSF into a TSF counter. The primary or the shadow access points transmit the TSF in each beacon, thereby propagating the TSF value to the wireless stations of the devices associated with a corresponding BSS. The devices receive the TSF from the access points and adopt it by adjusting a delay in a receive path. In an embodiment, the wireless stations associated with the devices keep track of time by incrementing the TSF. For each receipt of a beacon, the devices adopt the TSF received so as to correct inaccuracies across the devices within the BSS upon or based on the receipt of the beacon. Also, in an embodiment, the devices use the TSF for waking up to receive beacon or for transmission of data. In an embodiment, a contention free operation for a plurality of BSSs within a wireless network system is enabled by allowing each of the BSSs to operate in separate frequency channels (for example, separate WLAN channels) based on a frequency multiplexing technique. Such a frequency multiplexing technique is explained herein with reference to FIGS. 9A-9C.

FIGS. 9A-9B depict a diagrammatic representation for illustrating contention free operation of a wireless network system 900, such as wireless network system 200, 300, 400, 500 and 600 of FIGS. 2, 3, 4, 5 and 6, by utilizing frequency multiplexing, in accordance with an embodiment. The wireless network system 900 is implemented over geographical area 902. The wireless network system 900 includes a plurality of access points, such as a first set of access points 904, 906 and 908 depicted in FIG. 9A and a second set of access points 910, 912 and 914 depicted in FIG. 9B. The access points 904, 906 and 908 have an overlapping physical coverage (roughly denoted by hexagonal areas, hereinafter referred to as cells, such as cells 916 and 918) with the access points 910, 912 and 914 respectively The wireless network system 900 further includes a distributed set of devices configured to be responsive to an alert situation implemented in the geographical area 902. Each cell may include a plurality of devices, such as device 920. Each device from among the plurality of devices comprises at least one wireless station configured to transmit data associated with the alert situation to two distinct access points (such as the first access point and the second access point of the plurality of access points) over separate frequency channels (for example, separate WLAN channels) as may be observed with each extent of shading denoting a frequency channel. For example, the device 920 may communicate with the access point 908 in cell 922 at a first Wi-Fi frequency and subsequently communicate with the access point 914 in the cell 922 at a second Wi-Fi frequency. As explained, with reference to FIGS. 2 to 8, each device may include a pair of wireless stations or a single wireless station in time multiplexing configuration for transmission of the alert data to the first access point and the second access point in the corresponding cell. Each access point with associated set of devices in a cell may define a BSS.

Several BSS with same extent of shading may use a same frequency, however, a frequency channel (for example, frequency of transmission) may be different for adjacent BSS to obviate interference and associated contention. In an embodiment, each wireless station of the at least one wireless station is configured to transmit the same data associated with the alert situation to a first access point (such as access point 908) and a second access point (such as access point 914) in the corresponding cell, and, where the first access point and the second access point configured to receive transmitted data associated with the alert situation are associated with one of different SSID and same SSID. In an embodiment, the plurality of access points and the at least one wireless station corresponding to the set of devices are configured to comply with at least one of a plurality of IEEE 802.11 protocols for the communication. Examples of IEEE 802.11 protocols may include but are not limited to IEEE 802.11a, IEEE 802.11b, IEEE 802.11g, IEEE 802.11n and IEEE 802.11ac wireless LAN protocols and the like. In an embodiment, each device from among the set of devices comprises a circuit from among one of 1) sensor, 2) actuator, and 3) user interface. In an embodiment, an existing WLAN infrastructure in the geographical area 902 may co-exist with a first WLAN being defined by the first set of access points and a second WLAN being defined by the second set of access points. The existing WLAN infrastructure may have overlapping cell configuration while utilizing a separate frequency channel in each BSS for communication purposes.

FIG. 9C depicts a block diagram for illustrating transmission of alert data to a server in a wireless network system 900 of FIGS. 9A and 9B, in accordance with an embodiment. More particularly, FIG. 9C depicts a first set of access points 930 (for example, including access points 932, 934, 936, 938, and 908) associated with the first WLAN and a second set of access points 940 (for example, including access points 942, 944, 946, 948, and 914) associated with the second WLAN. The first set of access points 930 and the second set of access points 940 are connected to a wired network, such as for example Ethernet, via hubs, bridges or daisy chains. In an embodiment, the first set of access points 930 and the second set of access points 940 also serve as repeaters or relay nodes doing packet forwarding. In FIG. 9C, a device 920 of FIGS. 9A-913, is depicted to be communicatively associated with the access point 908 associated with the first WLAN and the access point 914 associated with second WLAN. In an embodiment, the access points 908 and 914 may also be located at same proximity from the device 920. In an embodiment, data associated with an alert situation is transmitted from the device 920 to each of the access points 908 and 914 via separate frequency channels and along two different paths to a server 950.

In an embodiment, the data is forwarded by each of the access point 908 and the access point 914 to corresponding adjacent access points, for example, the access point 914 forwards the data to an access point 944, which forwards the data to several other adjacent access points and so on until the data reaches an Ethernet-connected access point, such as access point 942. In a similar fashion, the data packet transmitted to the access point 908 is forwarded to an Ethernet-connected access point 932. In an embodiment, the data packet transmitted to the access point 908 may also be forwarded to an access point 936, which forwards the data to several other adjacent access points and so on until the data reaches an Ethernet-connected access point 938 and the data packet transmitted to the access point 914 may also be forwarded to an access point 946, which forwards the data to several other adjacent access points and so on until the data reaches an Ethernet-connected access point 948. At the Ethernet-connected access points, the data enters an Ethernet cable network 980 and is routed to the server 950. It is noted that although the Ethernet cable network 980 is depicted in FIG. 9C, the wireless network system 900 may include a wireless backhaul network as explained herein with reference to FIG. 6. Further, the server 950 may be similar to the servers explained herein with reference to FIGS. 2 and 8.

Without in any way limiting the scope, interpretation, or application of the claims appearing below, advantages of one or more of the exemplary embodiments disclosed herein include using a protocol-compliant WLAN network to connect very large number of distributed devices, thereby enabling ease of building, maintaining and expansion of the wireless network system using devices from multiple competing vendors. Also, the present technology may be deployed economically, by maintaining the device density to be higher than access point density. A number of additional WLAN access points required to deploy the wireless network system is at-least an order of magnitude less than the number of devices in the wireless network system, thereby making the implementation of the wireless network system commercially feasible. For example, devices may be deployed for every P meters (in) compared to access points needed that are deployed for every Q m, with the constraint that P<<Q, rendering access point expenses to be amortized over device expense. Additionally, the present technology also provides high peak capacity to cover multi Mbps full-duplex traffic as and when needed, for example, video/audio scan and emergency audio announcements capabilities may be provided to the devices in the event of a fire. Moreover, the present technology achieves lower power consumption by using battery operated devices, by implementing a tight time synchronization within each BSS, by narrowing the transmit durations and minimizing collisions for devices, and by using protocol-compliant accurate time-sync of the devices with the access points. Also, the present technology, optimizes one or more power-save parameters within the wireless network system, for example, by providing longer beacon interval, larger delivery traffic indication message (a beacon frame from access point), by providing longer association timeouts, and by enabling a contention free data transmission that includes use of protocols like PCF/HCCA and the like. In several embodiments, a NAV may be used to briefly silence the infrastructure access points and stations that geographically overlaps the BSS of the present technology.

Although the present technology has been described with reference to specific exemplary embodiments, it is noted that various modifications and changes may be made to these embodiments without departing from the broad spirit and scope of the present technology. For example, the various devices, modules, analyzers, generators, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the various electrical structures may be embodied using transistors, logic gates, and electrical circuits (for example, application specific integrated circuit (ASIC) circuitry and/or in Digital Signal Processor (DSP) circuitry).

Particularly, the components of the wireless network systems 200, 300, 400, 500, and 600 of the present technology may be enabled using software and/or using transistors, logic gates, and electrical circuits (for example, integrated circuit circuitry such as ASIC circuitry). Various embodiments of the present disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. Additionally, a tangible data storage device may be embodied as one or more volatile memory devices, one or more non-volatile memory devices, and/or a combination of one or more volatile memory devices and non-volatile memory devices.

Also, techniques, devices, subsystems described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled with each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology. Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A wireless network system comprising;
at least two access points; and
a distributed set of devices communicatively associated with the at least two access points, each device from among the distributed set of devices comprising a pair of wireless stations, each wireless station from among the pair of wireless stations configured to transmit data associated with an alert situation to a distinct access point from among the at least two access points, and a communication between one or more access points from among the at least two access points and one or more wireless stations from among the pairs of wireless stations corresponding to the distributed set of devices being synchronized based on a timing synchronization information shared by at least two basic service sets (BSSs) corresponding to the at least two access points.

2. The wireless network system of claim 1, wherein the at least two access points and the pairs of wireless stations are configured to comply with at least one of a plurality of Institute of Electrical and Electronics Engineers (IEEE) 802.11 protocols for the communication.

3. The wireless network system of claim 1, wherein each wireless station from among the pair of wireless stations comprises a radio operable individually based on an associated wireless context, wherein the radio is enabled for a predetermined duration periodically based on a time-sharing paradigm.

4. The wireless network system of claim 1, wherein each wireless station from among the pair of wireless stations is configured to transmit the same data associated with the alert situation to distinct access points from among the at least two access points.

5. The wireless network system of claim 4, wherein the distinct access points configured to receive the transmitted data associated with the alert situation are associated with different service set identifications (SSIDs).

6. The wireless network system of claim 4, wherein the distinct access points configured to receive the transmitted data associated with the alert situation are associated with a same SSID.

7. The wireless network system of claim 6, wherein the distinct access points comprises a primary access point and a secondary access point associated with same basic service set identification (BSSID), and wherein the secondary access point is configured to perform one or more functions associated with the corresponding primary access point in an event of operational failure of the primary access point.

8. The wireless network system of claim 1, further comprising:
a server configured to receive the data associated with the alert situation from the at least two access points, wherein the data is received over at least one of a wireless backhaul connection and a wired backhaul connection.

9. The wireless network system of claim 8, wherein the server is configured to periodically transmit the timing synchronization information in form of a timing synchronization function (TSF) to the at least two basic service sets (BSSs) corresponding to the at least two access points for subsequent propagation to the pairs of wireless stations at periodic intervals for synchronizing the transmission of the data associated with the alert situation through a same frequency channel.

10. The wireless network system of claim 1, wherein the at least two access points are configured to dynamically increase bandwidth allocation to at least one wireless station from among the pairs of wireless stations corresponding to the distributed set of devices upon an occurrence of the alert situation.

11. The wireless network system of claim 1, wherein each access point from among the at least two access points is configured to be operable in a Wi-Fi repeater mode for propagation of the data associated with the alert situation.

12. The wireless network system of claim 1, wherein each device from among the distributed set of devices comprises a circuit from among one of (1) a sensor, (2) an actuator, and (3) a user interface.

13. A wireless network system comprising:
at least two access points; and
a distributed set of devices communicatively associated with the at least two access points, each device from among the distributed set of devices comprising a wireless station configured to periodically switch wireless contexts based on a time-sharing paradigm for transmission of data associated with an alert situation to distinct access points from among the at least two access points, and a communication between one or more access points from among the at least two access points and one or more wireless stations corresponding to the distributed set of devices being synchronized based on a timing synchronization information shared by at least two basic service sets (BSSs) corresponding to the at least two access points.

14. The wireless network system of claim 13, wherein the at least two access points and the one or more wireless stations are configured to comply with at least one of a plurality of Institute of Electrical and Electronics Engineers (IEEE) 802.11 protocols for the communication, and wherein each device from among the distributed set of devices comprises a circuit from among one of (1) a sensor, (2) an actuator, and (3) a user interface.

15. The wireless network system of claim 13, wherein the wireless station is configured to transmit the same data associated with the alert situation to the distinct access points, and wherein the distinct access points are associated with one of different service set identifications (SSIDs) and a same SSID.

16. The wireless network system of claim 13, further comprising:
a server configured to receive the data associated with the alert situation from the at least two access points, wherein the data is received over at least one of a wireless backhaul connection and a wired backhaul connection.

17. The wireless network system of claim 16, wherein the server is configured to periodically transmit the timing synchronization information in form of a timing synchronization function (TSF) to the at least two basic service sets (BSSs) corresponding to the at least two access points at least two access points for subsequent propagation to the one or more wireless stations at periodic intervals for synchronizing the transmission of the data associated with the alert situation through a same frequency channel.

18. A wireless network system comprising:
a plurality of access points; and
a distributed set of devices communicatively associated with the plurality of access points, each device from among the distributed set of devices comprising at least one wireless station configured to transmit data associated with an alert situation to two distinct access points from among the plurality of access points through separate frequency channels.

19. The wireless network system of claim 18, wherein each wireless station of the at least one wireless station is configured to transmit the same data associated with the alert situation to the two distinct access points from among the plurality of access points, and wherein the distinct access points configured to receive transmitted data are associated with one of different service set identifications (SSIDs) and a same SSID.

20. The wireless network system of claim 18, wherein the plurality of access points and the at least one wireless station corresponding to the distributed set of devices are configured to comply with at least one of a plurality of Institute of Electrical and Electronics Engineers (IEEE) 802.11 protocols for the communication, and wherein each device from among the distributed set of devices comprises a circuit from among one of (1) a sensor, (2) an actuator, and (3) a user interface.
